(19) United States
(12) Patent Application Publication
(10) Pub. No.: US 2026/0348561 A1
(43) Pub. Date: Nov. 5, 2026

(54) LIGHT SOURCE BRACKET AND LIGHTING FIXTURE

(71) Applicants: OPPLE LIGHTING CO., LTD., Shanghai (CN); SUZHOU OPPLE LIGHTING CO., LTD., Suzhou City (CN)

(72) Inventor: Quanbiao WANG, Shanghai (CN)

(73) Assignees: OPPLE LIGHTING CO., LTD., Shanghai (CN); SUZHOU OPPLE LIGHTING CO., LTD., Suzhou City (CN)

(21) Appl. No.: 19/725,072

(22) Filed: Jun. 30, 2026

Related U.S. Application Data
(63) Continuation of application No. PCT/CN2024/143236, filed on Dec. 27, 2024.

(30) Foreign Application Priority Data
Dec. 31, 2023 (CN) 202311869236.4
Dec. 31, 2023 (CN) 202323669867.X

(51) Int. Cl. F21V 17/10; F21S 8/02; F21V 17/16; F21V 23/00

(52) U.S. Cl. CPC F21V 17/104; F21S 8/02; F21V 17/16; F21V 23/001

(57) ABSTRACT

A light source bracket for use in a lighting fixture includes a mounting portion configured to detachably mount a light source assembly and an outer edge portion disposed around the mounting portion. The outer edge portion includes a wire fixing cavity through which a power cord passes. The wire fixing cavity extends away from the mounting portion and is configured to engage a wire passing groove formed in a housing of the lighting fixture. A light source assembly mounted to the light source bracket is electrically connected to the power cord, and the wire fixing cavity receives and retains the power cord while routing the power cord through the housing. A lighting fixture including the light source bracket and an optical module is also disclosed.

### CROSS-REFERENCE TO RELATED DISCLOSURES

This disclosure is based upon and claims the priority of PCT patent disclosure No. PCT/CN2024/143236 filed on Dec. 27, 2024, which claims priority to the Chinese patent disclosure No. 202311869236.4 filed on Dec. 31, 2023 and the Chinese patent disclosure No. 202323669867.X filed on Dec. 31, 2023, the entire contents of which are hereby incorporated by reference herein for all purposes.

### TECHNICAL FIELD

The present disclosure relates to a light source bracket and a lighting fixture, falling within the technical field of illumination.

### BACKGROUND

Sometimes, a lighting fixture includes a housing and a light source module. The light source module includes a light source bracket, a light source assembly and power cords.

### SUMMARY

The present disclosure provides a light source bracket for use in a lighting fixture and a lighting fixture including the light source bracket.

Accordingly, the light source bracket may include a mounting portion configured to detachably mount a light source assembly and an outer edge portion surrounding the mounting portion. The outer edge portion is provided with a wire fixing cavity configured to receive a power cord electrically connected to the light source assembly. The wire fixing cavity extends away from the mounting portion and is configured to engage a wire passing groove formed in a housing of the lighting fixture, thereby routing and securing the power cord relative to the housing.

It is to be understood that both the foregoing general description and the following detailed description are exemplary and explanatory only and are not restrictive of the present disclosure.

### BRIEF DESCRIPTION OF DRAWINGS

FIG. 1 is a schematic structural diagram of a first example of a lighting fixture according to the present disclosure;

FIG. 2 is an exploded view of the lighting fixture shown in FIG. 1;

FIG. 3 is a schematic cross-sectional diagram of the lighting fixture shown in FIG. 1;

FIG. 4 is a schematic structural diagram of a first housing in FIG. 2;

FIG. 5 is a schematic structural diagram of a second housing in FIG. 2;

FIG. 6 is a schematic structural diagram of the second housing in FIG. 5 viewed from another perspective;

FIG. 7 is a schematic structural diagram of the light source bracket in FIG. 2;

FIG. 8 is a schematic structural diagram of the light source bracket in FIG. 7 viewed from another perspective;

FIG. 9 is an assembly view of the light source bracket shown in FIG. 7 mounted with a light source assembly and a power cord;

FIG. 10 is a schematic structural diagram of an insulating member in FIG. 2;

FIG. 11 is a schematic structural diagram of a micro-prism reflector in FIG. 2; and

FIG. 12 is a schematic structural diagram of an optical module implemented as a lens assembly.

### DETAILED DESCRIPTION

To make the objectives, technical solutions and advantages of the present disclosure clearer, the present disclosure will be described in detail below with reference to the accompanying drawings and examples.

It should be noted here that, to avoid obscuring the present disclosure due to unnecessary details, only structures and/or processing steps closely related to the solution of the present disclosure are shown in the accompanying drawings, and other details less relevant to the present disclosure are omitted.

In addition, it should be noted that the terms “include”, “comprise” or any other variant thereof are intended to cover non-exclusive inclusion, such that a process, method, article or device including a series of elements not only includes those elements, but also includes other elements not explicitly listed, or elements inherent to such a process, method, article or device.

Sometimes, the light source assembly and the light source bracket are either integrally manufactured or a specific light source bracket is fixedly assembled with a dedicated light source assembly. As the core component of the lighting fixture, the light source assembly is prone to damage. When the light source assembly fails and requires maintenance, the entire module has to be replaced, leading to high maintenance costs. Furthermore, the power cords are electrically connected to the light source assembly, while the light source bracket is not provided with any structure for securing the power cords. Consequently, the power cords are susceptible to damage from pulling and tugging, shortening the service life of the lighting fixture.

In view of the above drawbacks, it is indeed necessary to propose a light source bracket and a lighting fixture to solve the foregoing problems.

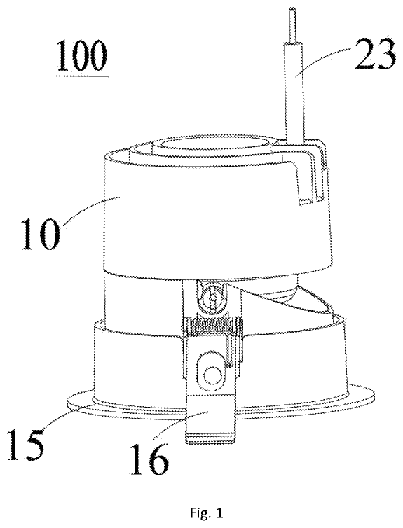

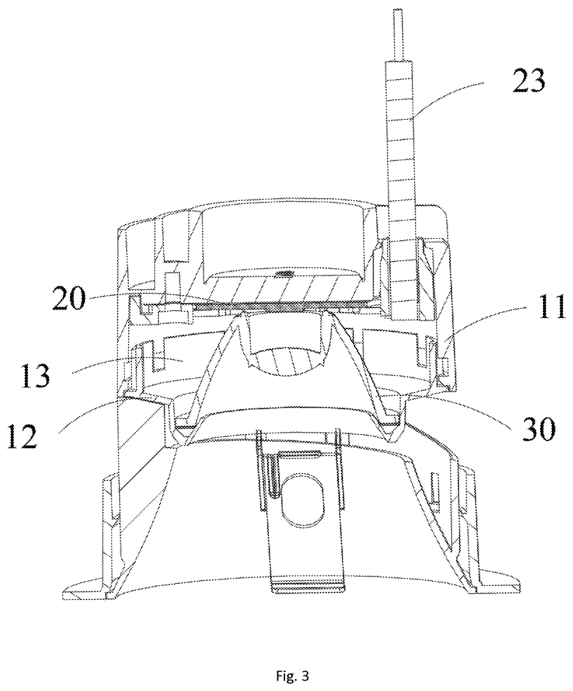

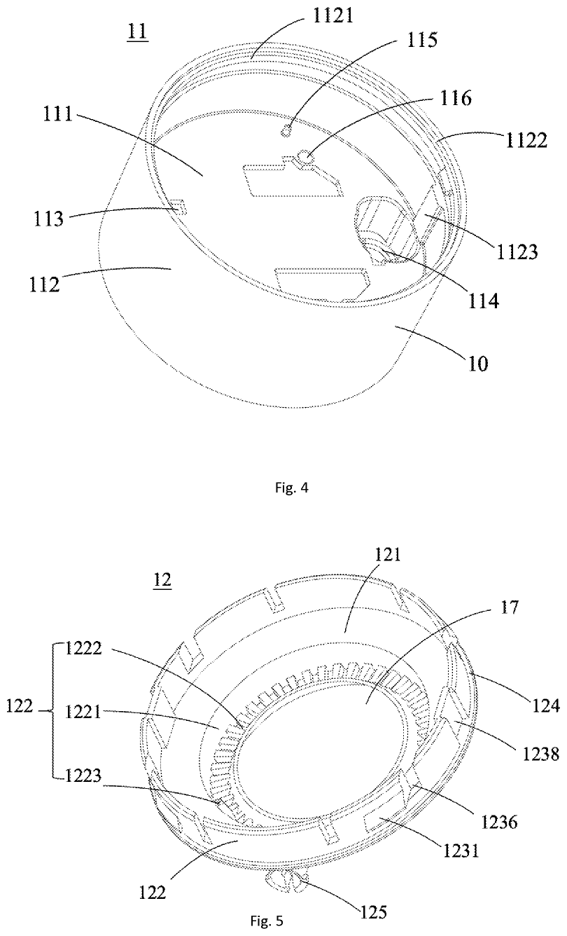

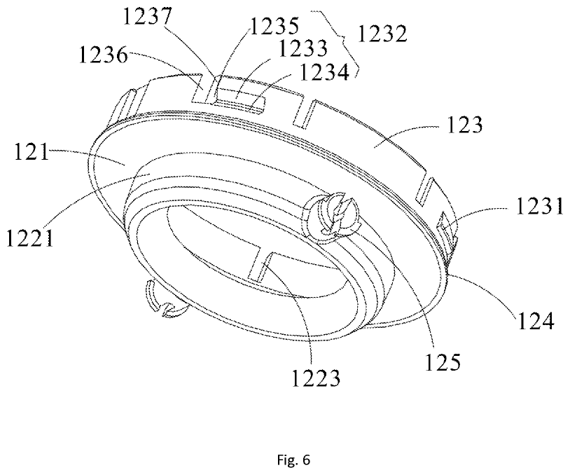

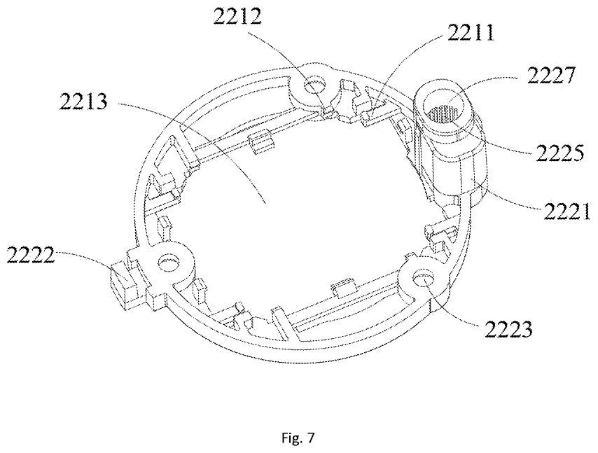

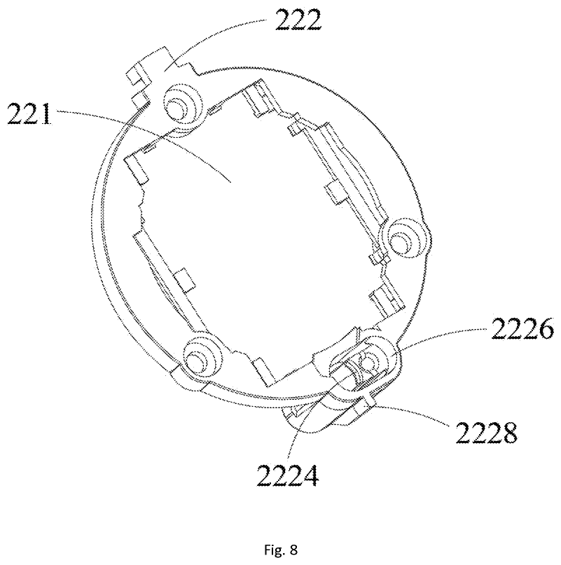

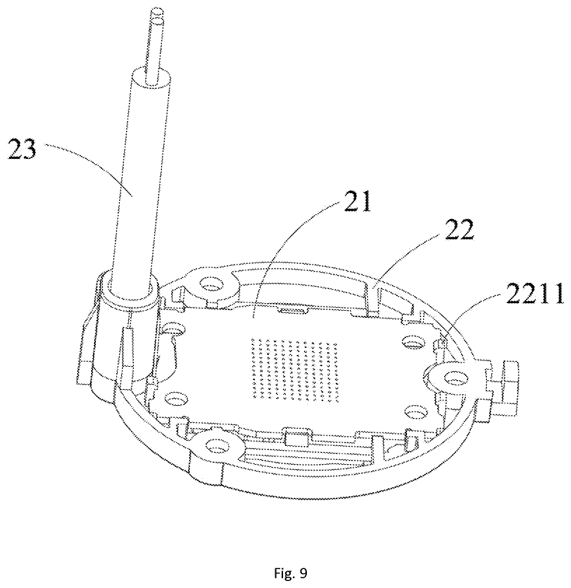

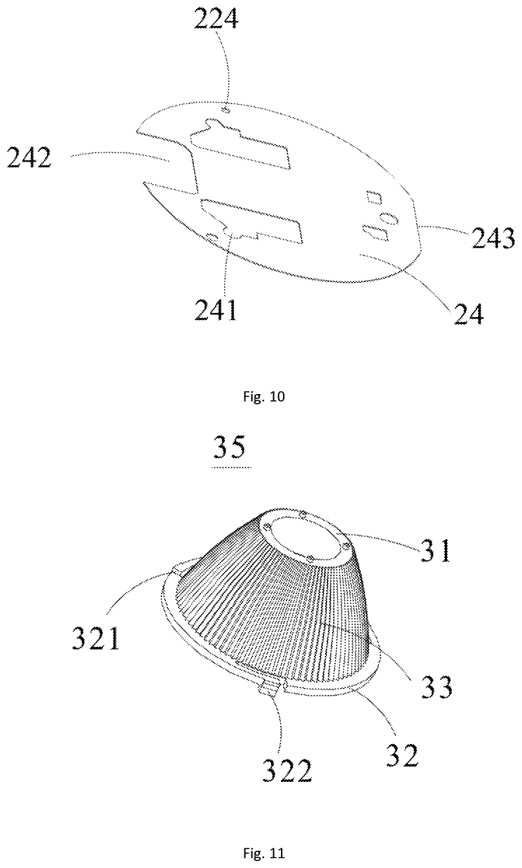

Please refer to FIGS. 1 to 12. The present disclosure provides a lighting fixture 100, which includes a housing 10, a light source module 20 and an optical module 30. The housing 10 includes a first housing 11, a second housing 12 and a third housing 14. A mounting cavity 13 is formed between the first housing 11 and the second housing 12. The light source module 20 is disposed inside the mounting cavity 13 and abuts against the first housing 11. The optical module 30 is disposed inside the mounting cavity 13 and located between the light source module 20 and the second housing 12.

Specifically, the housing 10 includes the first housing 11, the second housing 12 and the third housing 14. The second housing 12 is disposed between the first housing 11 and the third housing 14, and connected to both the first housing 11 and the third housing 14, respectively. The first housing 11 and the second housing 12 are engaged, and a mounting cavity 13 for installing the light source module 20 and the optical module 30 is formed between the first housing 11 and the second housing 12. The light source module 20 is mainly connected to the first housing 11, and the optical module 30 is sandwiched between the light source module 20 and the second housing 12. The second housing 12 and the third housing 14 are rotatably connected. The third housing 14 is used for connecting to an installation base. Rotating the second housing 12 drives the first housing 11 to rotate synchronously, thereby adjusting the illumination direction of the lighting fixture 100.

The first housing 11 includes a mounting wall 111 and a connecting wall 112 extending from the mounting wall 111 toward the second housing 12. The mounting wall 111 is used for mounting and connecting the light source module 20, and the connecting wall 112 is used for mounting the second housing 12 in an engagement manner.

The mounting wall 111 is provided with a wire passing groove 114 for the power cord 23 to pass therethrough. The wire passing groove 114 is recessed from the mounting wall 111 in a direction away from the mounting cavity 13. The wire passing groove 114 includes a first port facing the mounting cavity 13 and a second port away from the mounting cavity 13. The area of the first port is larger than that of the second port. This arrangement facilitates the wire fixing cavity 2221 engaged with the power cord 23 to enter the wire passing groove 114 through the first port, while being limited and clamped by the second port.

The light source module 20 includes a light source assembly 21, a light source bracket 22 and a power cord 23. The light source assembly 21 is electrically connected to the power cord 23 and detachably connected to the light source bracket 22.

The light source bracket 22 includes a mounting portion 221 for installing the light source assembly 21, and an outer edge portion 222 disposed on the periphery of the mounting portion 221.

The mounting portion 221 is used for detachably mounting the light source assembly 21. Such detachable mounting design enables the light source bracket 22 to be adapted to different types of light source assemblies 21. For example, the light source assembly 21 can be an insulated light source assembly 21 or a non-insulated light source assembly 21, such as a non-isolated 7070 light source assembly 21, an insulated 3535 light source assembly 21, etc.

Further, the mounting portion 221 is provided with an engagement assembly for engagement with the light source assembly 21. The engagement assembly realizes detachable connection of the light source assembly 21 to the mounting portion 221.

Preferably, a notch 2213 is formed in the middle of the mounting portion 221, and the light source assembly 21 is disposed at the notch 2213. The notch 2213 allows the light-emitting components of the light source assembly 21 to emit light toward the optical module 30 through the notch. In addition, the notch 2213 facilitates heat dissipation of the light source assembly 21.

The engagement assembly includes a first engagement portion 2211 horizontally extending from the outer edge portion 222 toward the mounting portion 221 (the notch 2213) and a second engagement portion 2212 vertically extending from the mounting portion 221. The first engagement portion 2211 and the second engagement portion 2212 cooperate to limit the light source assembly 21 in the vertical direction.

Optionally, the first engagement portion 2211 is a support arm which is disposed on a side surface of the outer edge portion 222 and extends toward the notch 2213, and a hook protruding upward is disposed at the end of the support arm. The second engagement portion 2212 is a convex arm disposed adjacent to the first engagement portion 2211 and extending vertically, and a hook is formed at the top of the convex arm.

Further, orthographic projections of the first engagement portion 2211 and the second engagement portion 2212 on the horizontal plane are offset from each other, and a height difference exists in the vertical direction. This arrangement endows the first engagement portion 2211 and the second engagement portion 2212 with elastic engagement performance, so as to be matched and engaged with various light source assemblies 21.

The outer edge portion 222 is disposed on the periphery of the mounting portion 221 and is provided with the wire fixing cavity 2221 for the power cord 23 to pass therethrough. The wire fixing cavity 2221 extends from the outer edge portion 222 in a direction away from the mounting portion 221, and a height difference exists between the plane where the highest point of the wire fixing cavity 2221 is located and the mounting portion 221. The wire fixing cavity 2221 is configured to be engaged with the wire passing groove 114 on the housing. A single wire fixing cavity 2221 can be engaged with both the power cord 23 and the housing, thus reducing structural parts and saving costs.

Optionally, the wire fixing cavity 2221 includes an inlet port 2226 and an outlet port 2227 disposed opposite to each other, and the cross-sectional area of the inlet port 2226 is larger than that of the outlet port 2227. This arrangement facilitates the power cord 23 to enter the wire fixing cavity 2221 through the inlet port 2226, and to exit from the outlet port 2227, so as to be electrically connected to external mains power.

An engagement structure for engagement with the power cord 23 is disposed inside the wire fixing cavity 2221, and the engagement structure is configured to fix and engage the power cord 23 within the wire fixing cavity 2221. This design fixes the power cord 23 inside the wire fixing cavity 2221 to prevent damage caused by pulling and tugging.

In this example, the engagement structure includes an elastic snap-fitting portion 2224 and a snap-fitting ridge 2225.

The elastic snap-fitting portion is an elastic snap-fitting disposed inside the wire fixing cavity 2221, with the snap-fitting facing the inner surface on the opposite side of the wire fixing cavity 2221. That is, the snap-fitting ridge 2225 is disposed on the inner surface opposite to the elastic snap-fitting portion 2224. A plurality of snap-fitting ridges 2225 extending along the extension direction of the wire fixing cavity 2221 are formed on this inner surface. The arrangement of the snap-fitting ridge 2225 and the elastic snap-fitting protrusion allows to fix the power cord 23 inside the wire fixing cavity 2221. Moreover, the elastic snap-fitting protrusion allows power cords 23 of different sizes to be fixed inside the wire fixing cavity 2221 in an engagement manner.

Further, an extension portion 2228 extending away from the wire fixing cavity 2221 is disposed on the external side of the wire fixing cavity 2221, and the extension portion 2228 is configured to engage the wire fixing cavity 2221 with the wire passing groove 114. Since the volume of the wire fixing cavity 2221 is smaller than that of the wire passing groove 114, the extension portion 2228 is disposed on the external side of the wire fixing cavity 2221 to realize engagement between the wire fixing cavity 2221 and the wire passing groove 114.

Further, an inclined guiding surface is formed on the extension portion 2228 to guide the wire fixing cavity 2221 into the wire passing groove 114 for engagement.

To realize rapid engagement between the light source bracket 22 and the first housing 11, the outer edge portion 222 is further provided with a first fool-proof portion 2222 for positioning connection with the first housing, and the first housing 11 is further provided with a second fool-proof portion 113 at a position corresponding to the first fool-proof portion 2222.

One of the first fool-proof portion 2222 and the second fool-proof portion 113 is a fool-proof protrusion, and the other is a fool-proof groove.

In this example, the first fool-proof portion 2222 is a fool-proof protrusion disposed on the light source bracket 22. The fool-proof protrusion extends outward from the outer periphery of the outer edge portion 222 and toward the first housing 11. The second fool-proof portion 113 is a fool-proof groove formed on the mounting wall 111. In other examples, the first fool-proof portion 2222 may be a fool-proof groove and the second fool-proof portion 113 may be a fool-proof protrusion, which is not limited by the present disclosure.

Further, to improve the stability of connection between the light source bracket 22 and the first housing, the outer edge portion 222 is further provided with a second mounting hole 2223 for fixedly connecting the light source bracket 22 to the housing. Correspondingly, the mounting wall is provided with a first mounting hole 116. A fastener passes through the first mounting hole 116 and the second mounting hole 2223 to fixedly connect the light source bracket 22 to the first housing 11.

Specifically, the fastener is configured to pass through the first mounting hole 116 and the second mounting hole 2223 to fix the light source bracket 22 and the light source assembly 21 on the mounting plate. The fastener may be a ST-type self-tapping screw and a M-type screw, including one ST-type screw and three M-type screws. The ST-type screw is an anti-pull screw to enhance the fixing effect with the light source bracket 22.

In this example, the light source assembly 21 is a non-insulated light source assembly. Therefore, an insulating member 24 is sandwiched between the non-insulated light source assembly 21 and the mounting wall 111. Preferably, the insulating member 24 is a thermally conductive insulating silicone cloth sandwiched between the light source assembly 21 and the mounting wall 111. The thermally conductive insulating silicone cloth is disposed between the light source assembly 21 and the mounting wall 111 of the first housing 11.

The mounting wall 111 of the first housing 11 is provided with a first positioning piece 115, and the insulating member 24 is correspondingly provided with a second positioning piece 224 positioned and connected to the first positioning piece 115.

Optionally, the first positioning piece 115 is a positioning post extending from the mounting wall 111 toward the mounting cavity 13. The second positioning piece 224 is a positioning hole formed on the thermally conductive insulating silicone cloth, and the positioning post is engaged into the positioning hole to realize positioning connection between the mounting wall 111 and the thermally conductive insulating silicone cloth.

Optionally, multiple positioning posts may be provided, for example two, and these two positioning posts are disposed on both sides of the mounting wall 111 at positions different from the second fool-proof portion 113 and the wire passing groove 114. Similarly, multiple positioning holes are disposed at positions matching the positions of the positioning posts.

Since the insulating member 24 is sandwiched between the light source assembly 21 and the mounting wall 111, the insulating member 24 is provided with avoidance structures to prevent blocking the installation of the light source bracket 22 on the mounting wall.

The avoidance structures include an avoidance hole 241 and a relief groove 242. The avoidance hole 241 is configured to avoid the second mounting hole 2223 on the light source bracket 22, and the relief groove 242 is configured to avoid the wire fixing cavity 2221 on the light source bracket 22.

In other examples, the light source module 20 may be an insulated light source module, that is, the light source assembly 21 detachably connected to the mounting portion 221 of the light source bracket 22 is an insulated light source assembly. The engagement structure on the mounting portion 221 fixedly engages the insulated light source assembly 21 with the light source bracket 22.

Since the light source bracket 22 is engaged with an insulated light source assembly 21, the mounting wall 111 of the first housing 11 may not be provided with the first positioning piece 115. Alternatively, the first positioning piece 115 is located in a gap of the insulated light source assembly 21 without affecting the installation of the light source bracket 22.

The insulated light source assembly 21 directly abuts against the mounting wall 111. The mounting wall 111 is provided with the second fool-proof portion 113, and the insulated, external, light source module 20 is correspondingly provided with the first fool-proof portion 2222. The first fool-proof portion 2222 is positioned and engaged with the second fool-proof portion 113. The structures of the second fool-proof portion 113 and the first fool-proof portion 2222 are the same as those in the second example and will not be repeated here.

Optionally, the optical module 30 is disposed on the light-emitting path of the light source assembly 21 and configured to control light emitted by the light source assembly 21. The optical module 30 may be either a micro-prism reflector 35 or a lens assembly 34, or other structural forms, which is not limited. The second housing 12 is also provided with a bearing portion 122 adapted to the optical module 30. The bearing portion 122 disposed on the second housing 12 can match multiple optical modules 30, which allows different optical elements to be selected according to different lighting requirements to realize multi-purpose lighting fixtures.

Please refer to FIG. 11. In this example, the optical module 30 is a micro-prism reflector 35.

The micro-prism reflector 35 includes a first end 31, a second end 32 and a side wall 33 connecting the first end 31 and the second end 32. The diameter of the first end 31 is smaller than that of the second end 32, and multiple micro-prism structures are formed on the side wall 33.

An abutting portion extending toward the light source assembly 21 is formed at the first end 31. Four abutting portions abut against the external side of the light-emitting components of the light source assembly 21, such that the first end 31 covers the external side of the light-emitting components. In this way, light emitted by the light-emitting components is adjusted after optical processing by the micro-prism reflector 35 before being emitted, so as to regulate the light-emitting state of the lighting fixture 100.

An edge portion extends outward from the end portion of the second end 32, and the edge portion is configured to abut and be installed inside the bearing portion 122 of the second housing 12. An engagement block extends from the edge portion toward the second housing 12, and correspondingly, an engagement recess is formed on the bearing wall 1222 of the bearing portion 122, so as to be engaged with the engagement block.

For rapid positioning and engagement, the bearing portion 122 of the second housing 12 is provided with a first positioning engagement portion 1223, and correspondingly, the edge portion is provided with a second positioning engagement portion 321 for positioning connection with the first positioning engagement portion 1223. Optionally, the first positioning engagement portion 1223 is a positioning rib disposed on the second extending wall 1221 of the bearing portion 122, and the second positioning engagement portion 321 is a positioning groove recessed inward from the edge portion.

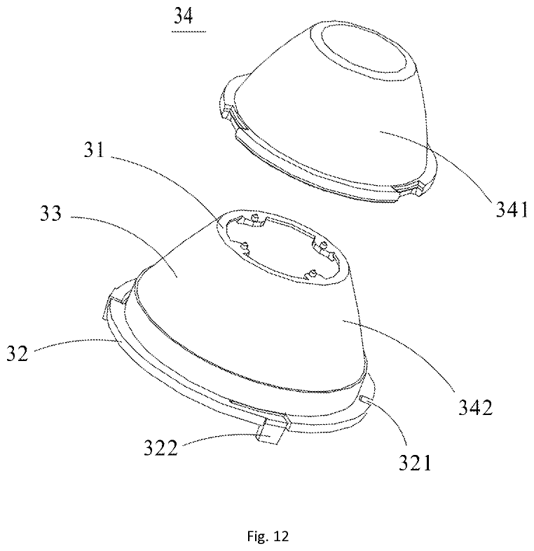

Please refer to FIG. 12. In other examples, the optical module 30 may also be a lens assembly 34 (e.g., a TR lens 341). The lens assembly 34 includes a lens 341 and a lens bracket 342. An installation position for mounting the lens 341 is formed inside the lens bracket 342, and a first end 31 and a second end 32 of the lens bracket 342 abut against the optical module 30 and the second housing 12 respectively.

The lens bracket 342 includes a first end 31, a second end 32 and a side wall 33 connecting the first end 31 and the second end 32. The side wall 33, the first end 31 and the second end 32 jointly enclose the installation position for the lens 341. The diameter of the first end 31 is smaller than that of the second end 32, a small-diameter end of the lens 341 is connected to the first end 31, and a large-diameter end of the lens 341 is connected to the second end 32.

An abutting portion extending toward the built-in light source assembly 21 is formed at the first end 31. Four abutting portions abut against the external side of the light-emitting components of the built-in light source assembly 21, such that the first end 31 covers the external side of the light-emitting components. Light emitted by the light-emitting components is adjusted after optical processing by the lens 341 before being emitted, so as to regulate the light-emitting state of the lighting fixture 100.

In addition, the first end 31 is the end with a smaller diameter, and an accommodating space 131 for non-light-emitting components outside the light-emitting components is formed between the side wall 33 connected to the first end 31 and the connecting wall 112 of the first housing 11. That is, non-light-emitting components (electrical components) on the first power board of the DOB integrated photoelectric light source can be installed in this accommodating space 131, thereby rationally utilizing the internal space of the housing 10 and reducing the volume of the lighting fixture 100.

An edge portion extends outward from the end portion of the second end 32, and the edge portion is configured to abut and be installed inside the bearing portion 122 of the second housing 12.

For rapid positioning and engagement, the bearing portion 122 of the second housing 12 is provided with a first positioning engagement portion 1223, and correspondingly, the edge portion is provided with a second positioning engagement portion 321 for positioning connection with the first positioning engagement portion 1223. Optionally, the first positioning engagement portion 1223 is a positioning rib disposed on the second extending wall 1221 of the bearing portion 122, and the second positioning engagement portion 321 is a positioning groove recessed inward from the edge portion.

Further, an engagement block extends from the edge portion toward the second housing 12, and correspondingly, an engagement recess is formed on the bearing wall 1222 of the bearing portion 122, so as to be engaged with the engagement block.

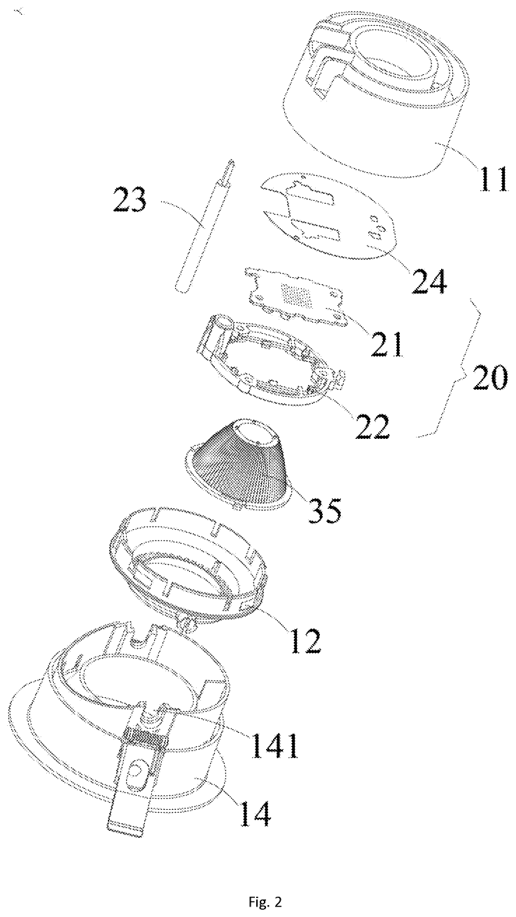

Please continue to refer to FIGS. 2 to 7. The first housing 11 is positioned and engaged with the second housing 12, and anti-disassembly and light leakage prevention effects can be achieved after engagement.

Specifically, the first housing 11 includes the mounting wall 111 and the connecting wall 112 extending from the mounting wall 111 toward the second housing 12. The connecting wall 112 is provided with at least two first snap-fitting portions 1121, which are configured to be engaged with the second snap-fitting portion 1231 on the second housing 12 to realize an anti-disassembly effect.

Optionally, in this example, the first snap-fitting portions 1121 are snap-fitting grooves disposed on the connecting wall 112 close to the second housing 12, and the snap-fitting grooves are annular grooves. Of course, in other examples, the first snap-fitting portions 1121 may also be snap-fitting protrusions 1232, which is not limited herein.

The connecting wall 112 includes an end portion close to the second housing 12, and a relief groove 1122 is formed on the inner side of the end portion. The relief groove 1122 is configured to accommodate the lip edge 124 of the second housing 12, so that the second housing 12 is completely wrapped inside the first housing 11 to achieve an effect of light leakage prevention.

Further, since the relief groove 1122 is also annular and is disposed below the snap-fitting groove, a snap-fitting step is formed between the relief groove 1122 and the snap-fitting groove, and the snap-fitting step abuts against the upper surface of the lip edge 124 of the second housing 12. Since the snap-fitting step is located below the snap-fitting groove, when the snap-fitting step is subjected to external force, the force bearing point is not located at the joint of the first snap-fitting portion 1121 and the second snap-fitting portion 1231, thereby preventing the first housing 11 from falling off.

The second housing 12 includes a base 121 and a first extending wall 123 extending from the base 121 toward the first housing 11. A light outlet 17 is formed on the inner side of the first extending wall 123, at least two second snap-fitting portions 1231 are disposed on the first extending wall 123, and a lip edge 124 extending outward is formed on the outer edge of the first extending wall 123. The first snap-fitting portion 1121 and the second snap-fitting portion 1231 are engaged, and the lip edge 124 is accommodated inside the relief groove 1122 and wrapped by the end portion. The engagement connection between the first snap-fitting portion 1121 and the second snap-fitting portion 1231 achieves an anti-disassembly effect. Meanwhile, after the first housing 11 and the second housing 12 are engaged and installed, the lip edge 124 of the second housing 12 is accommodated inside the relief groove 1122 of the first housing 11 and wrapped by the end portion of the first housing 11, thereby realizing an effect of light leakage prevention.

In this example, the second snap-fitting portion 1231 is a snap-fitting protrusion 1232 disposed on the first extending wall 123. Of course, in other examples, the second snap-fitting portion 1231 may also be a snap-fitting groove.

Further, the snap-fitting protrusion 1232 is an annular inclined snap-fitting protrusion. The snap-fitting protrusion 1232 includes an engaging surface 1234 facing the second housing 12, an inclined guiding surface 1233 facing the lip edge 124, and two inclined end surfaces 1235 connecting the engaging surface 1234 and the inclined guiding surface 1233. The edge of the engaging surface 1234 connecting the two inclined end surfaces 1235 is an arc edge. That is, the engaging surface 1234 of the snap-fitting protrusion 1232 is an arc surface, which can match the arc surface of the snap-fitting groove. The inclined snap-fitting protrusion 1232 increases the contact area between the snap-fitting protrusion 1232 and the snap-fitting groove to achieve an anti-disassembly effect. The inclined guiding surface 1233 guides the engagement between the second housing 12 and the first housing 11.

Optionally, multiple snap-fitting protrusions 1232 are disposed on the first extending wall 123 along the circumferential direction of the first extending wall 123, and every two adjacent snap-fitting protrusions 1232 are disposed in mirror symmetry. This arrangement improves the stability of engagement between the snap-fitting protrusions 1232 and the snap-fitting grooves.

The connecting wall 112 is further provided with a force relief groove 1236 inclined in the same direction as the snap-fitting protrusion 1232. The force relief groove 1236 is disposed adjacent to the snap-fitting protrusion 1232, and each force relief groove 1236 is provided with a pair of inclined surfaces 1237. The inclined surface 1237 adjacent to the snap-fitting protrusion 1232 is connected to the inclined end surface 1235 and located on the same plane. The force relief groove 1236 reduces the deformation distance of the first extending wall 123.

Further, to realize rapid engagement between the first housing 11 and the second housing 12, the inner side of the connecting wall 112 is provided with a first mating portion 1123 for mating with the second housing 12. The side of the first extending wall 123 facing the lip edge 124 is correspondingly provided with a second mating portion 1238 positioned and engaged with the first mating portion 1123.

Optionally, one of the first mating portion 1123 and the second mating portion 1238 is a mating protrusion, and the other is a mating groove.

In this example, the first mating portions 1123 is a mating protrusion protruding inward from the inner side of the connecting wall 112 toward the mounting cavity 13. The mating protrusion is disconnected at the position of the snap-fitting groove to avoid the snap-fitting groove. In addition, a guiding surface 1233 is formed on the side of the mating protrusion facing the second housing 12 to facilitate installation.

The second mating portion 1238 is a mating groove recessed inward from the external side of the first extending wall 123, so as to be positioned and engaged with the mating protrusion.

Further, the mating protrusion is disposed below the wire passing groove 114. Therefore, the insulating member 24 is provided with a relief groove 242 at a position corresponding to the mating protrusion, and the relief groove 242 is located below the wire fixing cavity.

Further, the second housing 12 is further provided with a bearing portion 122 for bearing optical components. The bearing portion 122 is recessed from the base 121 in a direction away from the first housing 11, and is disposed surrounding the light outlet 17.

The bearing portion 122 includes a second extending wall 1221 extending in a direction away from the first housing 11, and a bearing wall 1222 extending inward from the second extending wall 1221 toward the light outlet 17. That is, the bearing wall 1222 is located on the inner side of the second extending wall 1221, and is configured to abut against the optical module 30. Multiple reinforcing ribs are formed on the bearing wall 1222, and gaps are formed between adjacent reinforcing ribs to form engagement recesses for engagement with the engagement blocks on the second housing 12.

The second extending wall 1221 is provided with a first positioning engagement portion 1223 for positioning and engagement with the optical module 30. Optionally, the first positioning engagement portion 1223 is a positioning rib disposed on the second extending wall 1221 of the bearing portion 122, and the positioning rib is positioned and engaged with the positioning groove on the optical module 30.

A mounting pivot 125 protruding outward is formed on the external side of the bearing portion 122, and the third housing 14 is correspondingly provided with a pivot groove 141. The mounting pivot 125 is positioned and engaged inside the pivot groove 141 to realize fixed connection between the second housing 12 and the third housing 14. Meanwhile, the mounting pivot 125 can rotate inside the pivot groove 141, which enables the second housing 12 to rotate relative to the third housing 14, for adjusting the light-emitting direction of the lighting fixture 100.

Further, the inner side of the third housing 14 is formed as a horn-shaped light-emitting channel, with the small opening close to the second housing 12 and the large opening close to the trim ring 15. Such arrangement increases the light-emitting area.

A notch 2213 is formed between the third housing 14 and the second housing 12, which can assist heat dissipation of the lighting fixture 100.

Further, a trim ring 15 is disposed on the side of the third housing 14 away from the second housing 12, and a circlip 16 is disposed on the trim ring 15. The circlip 16 is configured to connect the lighting fixture 100 to an installation base.

Further, to improve heat dissipation performance, a plurality of heat dissipation fins are disposed on the side of the first housing 11 facing away from the mounting cavity 13. The housing 10 is provided with multiple first housings 11 with identical internal structures but different heights of heat dissipation fins, and different first housings 11 can be replaced according to the power of the light source module 20.

In summary, for the light source bracket 22 of the present disclosure, the mounting portion 221 is disposed to realize detachable installation of the light source assembly 21, so that the light source bracket 22 can be adapted to multiple types of light source assemblies 21; and the wire fixing cavity 2221 is disposed to realize engagement with both the power cord 23 and the housing through a single cavity, thus reducing structural components and lowering production costs.

An objective of the present disclosure is to provide a light source bracket and a lighting fixture. The light source bracket features a simple structure, enables detachable mounting of light source assemblies, and is equipped with a single wire fixing cavity that can be engaged with both the power cord and the housing respectively.

To achieve the above objective, the present disclosure provides a light source bracket for use in a lighting fixture. The lighting fixture includes a housing, a light source assembly disposed inside the housing, and a power cord at least partially disposed within the housing. The light source assembly is electrically connected to the power cord. The light source bracket includes:
a mounting portion configured for detachably mounting the light source assembly;
an outer edge portion disposed on a periphery of the mounting portion, the outer edge portion is provided with a wire fixing cavity through which the power cord passes, the wire fixing cavity extends from the outer edge portion in a direction away from the mounting portion, a height difference exists between a plane where a highest point of the wire fixing cavity is located and the mounting portion, and the wire fixing cavity is configured to be engaged with a wire passing groove formed on the housing.

Optionally, an engagement structure is disposed inside the wire fixing cavity, and the engagement structure is configured to engage and fix the power cord within the wire fixing cavity.

Optionally, the engagement structure includes an elastic snap-fitting portion and a snap-fitting ridge, and the snap-fitting ridge is disposed on an inner surface opposite to the elastic snap-fitting portion.

Optionally, an extension portion extending away from the wire fixing cavity is further disposed on an external side of the wire fixing cavity, and the extension portion is configured to engage the wire fixing cavity with the wire passing groove.

Optionally, the outer edge portion is further provided with a first fool-proof portion for positioning and connecting with the housing. The first fool-proof portion is a fool-proof protrusion or a fool-proof groove; and/or the outer edge portion is further provided with a second mounting hole for fixedly connecting the light source bracket to the housing.

Optionally, the mounting portion is provided with an engagement assembly for engagement with the light source assembly. The engagement assembly includes: a first engagement portion horizontally extending from the outer edge portion toward the mounting portion, and a second engagement portion vertically extending from the mounting portion. The first engagement portion and the second engagement portion cooperate to limit the light source assembly in a vertical direction.

Optionally, the wire fixing cavity includes an inlet port and an outlet port disposed opposite to each other, and a cross-sectional area of the inlet port is larger than that of the outlet port.

The present disclosure further provides a lighting fixture, including a housing, a light source assembly, a power cord, and the light source bracket described above. The light source assembly is disposed inside the housing, the power cord is at least partially disposed inside the housing, and the light source assembly is electrically connected to the power cord.

Optionally, the lighting fixture further includes an insulating member sandwiched between the light source assembly and the housing. The insulating member is provided with a second positioning piece for positioning and connecting with the housing. The insulating member is further provided with an avoidance hole and a relief groove. The avoidance hole is configured to avoid the second mounting hole on the light source bracket, and the relief groove is configured to avoid the wire passing groove on the housing.

Optionally, the lighting fixture further includes an optical module disposed on a light-emitting path of the light source assembly and configured to control light emitted by the light source assembly. The optical module is a micro-prism reflector or a lens assembly.

The present disclosure may include dedicated hardware implementations such as disclosure specific integrated circuits, programmable logic arrays and other hardware devices. The hardware implementations can be constructed to implement one or more of the methods described herein. Examples that may include the apparatus and systems of various implementations can broadly include a variety of electronic and computing systems. One or more examples described herein may implement functions using two or more specific interconnected hardware modules or devices with related control and data signals that can be communicated between and through the modules, or as portions of an disclosure-specific integrated circuit. Accordingly, the system disclosed may encompass software, firmware, and hardware implementations. The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. The module refers herein may include one or more circuit with or without stored code or instructions. The module or circuit may include one or more components that are connected.

The above examples are only used to illustrate the technical solutions of the present disclosure rather than to limit them. Although the present disclosure has been described in detail with reference to examples, those skilled in the art should understand that modifications or equivalent substitutions can be made to the technical solutions of the present disclosure without departing from the spirit and scope of the technical solutions of the present disclosure.

1. A light source bracket for use in a lighting fixture, wherein the lighting fixture comprises a housing, a light source assembly disposed inside the housing, and a power cord at least partially disposed inside the housing, and the light source assembly is electrically connected to the power cord,
wherein the light source bracket comprises:
a mounting portion, configured to detachably mount the light source assembly; and
an outer edge portion, disposed on a periphery of the mounting portion, wherein the outer edge portion is provided with a wire fixing cavity through which the power cord passes, the wire fixing cavity extends from the outer edge portion in a direction away from the mounting portion, a height difference exists between a plane where a highest point of the wire fixing cavity is located and the mounting portion, and the wire fixing cavity is configured to be engaged with a wire passing groove formed on the housing.

2. The light source bracket according to claim 1, wherein an engagement structure is disposed inside the wire fixing cavity, and the engagement structure is configured to engage and retain the power cord within the wire fixing cavity.

3. The light source bracket according to claim 2, wherein the engagement structure comprises an elastic snap-fitting portion and a snap-fitting ridge, and the snap-fitting ridge is disposed on an inner surface opposite to the elastic snap-fitting portion.

4. The light source bracket according to claim 1, wherein an extension portion extending away from the wire fixing cavity is further disposed on an external side of the wire fixing cavity, and the extension portion is configured to engage the wire fixing cavity with the wire passing groove.

5. The light source bracket according to claim 1, wherein
the outer edge portion is further provided with a first fool-proof portion configured to be positioned and connected with the housing, the first fool-proof portion is a fool-proof protrusion or a fool-proof groove; and
the outer edge portion is further provided with a second mounting hole for fixedly connecting the light source bracket to the housing.

6. The light source bracket according to claim 1, wherein the mounting portion is provided with an engagement assembly for engagement with the light source assembly, the engagement assembly comprises a first engagement portion horizontally extending from the outer edge portion toward the mounting portion and a second engagement portion vertically extending from the mounting portion, and the first engagement portion and the second engagement portion cooperate to limit the light source assembly in a vertical direction.

7. The light source bracket according to claim 1, wherein the wire fixing cavity comprises an inlet port and an outlet port disposed opposite to each other, and a cross-sectional area of the inlet port is larger than that of the outlet port.

8. A lighting fixture, comprising a housing, a light source assembly, a power cord, and the light source bracket according to claim 1, wherein
the light source assembly is disposed inside the housing, the power cord is at least partially disposed inside the housing, and the light source assembly is electrically connected to the power cord.

9. The lighting fixture according to claim 8, further comprising an insulating member sandwiched between the light source assembly and the housing, wherein the insulating member is provided with a second positioning piece configured to be positioned and connected with the housing, the insulating member is further provided with an avoidance hole and a relief groove, the avoidance hole is configured to avoid a second mounting hole on the light source bracket, and the relief groove is configured to avoid the wire passing groove on the housing.

10. The lighting fixture according to claim 8, further comprising an optical module disposed on a light-emitting path of the light source assembly and configured to control light emitted by the light source assembly, wherein the optical module comprises a micro-prism reflector or a lens assembly.

11. The light source bracket according to claim 1, wherein
the outer edge portion is further provided with a first fool-proof portion configured to be positioned and connected with the housing, the first fool-proof portion is a fool-proof protrusion or a fool-proof groove; or
the outer edge portion is further provided with a second mounting hole for fixedly connecting the light source bracket to the housing.

12. The light source bracket according to claim 1, wherein the mounting portion comprises a notch configured to expose light-emitting components of the light source assembly.
